(19) United States
(12) Patent Application Publication
(10) Pub. No.: US 2014/0234719 A1
(43) Pub. Date: Aug. 21, 2014

(54) HIGH CAPACITY LITHIUM-ION ELECTROCHEMICAL CELLS AND METHODS OF MAKING SAME

(71) Applicant: 3M INNOVATIVE PROPERTIES COMPANY, St. Paul, MN (US)

(72) Inventor: Leif Christensen, St. Paul, MN (US)

(73) Assignee: 3M INNOVATIVE PROPERTIES COMPANY, St. Paul, MN (US)

(21) Appl. No.: 14/343,422

(22) PCT Filed: Sep. 13, 2012
(86) PCT No.: PCT/US2012/055053

§ 371 Date: Mar. 7, 2014

Related U.S. Application Data
(60) Provisional application No. 61/537,294, filed on Sep. 21, 2011.

(51) Int. Cl. H01M 4/505; H01M 4/04; H01M 4/525

(52) U.S. Cl. CPC H01M 4/505; H01M 4/525; H01M 4/04; H01M 2004/028
USPC 429/223; 429/231.3; 429/224; 29/623.1

(57) ABSTRACT

High capacity lithium-ion electrochemical cells and methods of making the same are provided that include a positive electrode that includes a lithium mixed metal oxide having a first irreversible capacity and a negative electrode that includes an alloy anode material having a first irreversible capacity when the anode is delithiated to 0.9 V vs. Li/Li⁺. The lithium mixed metal oxide includes at least one of nickel, cobalt, and manganese. The alloy anode compound includes at least one of silicon and tin. The first cycle irreversible capacity of the positive electrode is greater than or equal to the first cycle irreversible capacity loss of the negative electrode.

### FIELD

This disclosure relates to high capacity lithium-ion electrochemical cells.

### BACKGROUND

Secondary lithium-ion electrochemical cells typically include a positive electrode that contains lithium in the form of a lithium transition metal oxide (typically layered or spinel-structured), a negative electrode (typically carbon or graphite), and an electrolyte. Examples of transition metal oxides that have been used for positive electrodes include lithium cobalt dioxide (LCO) and lithium nickel dioxide. Other exemplary lithium transition metal oxide materials that have been used for positive electrodes include mixtures of cobalt, nickel, and/or manganese oxides. Most commercial lithium-ion electrochemical cells operate by reversible lithium intercalation and extraction into both the active negative electrode material and the active positive electrode material. Increases in energy density of lithium-ion electrochemical cells have, thus far, mainly been the result of an engineering approach, accomplished by incremental densification of both the negative and positive electrodes, utilizing the same active materials (LCO and graphite) both having low irreversible capacity, rather than through introduction of new, higher capacity materials.

High energy lithium-ion electrochemical cells having high discharge capacity upon cycling are described, for example, in U.S. Pat. App. Publ. No. 2009/0263707 (Buckley et al.). These cells use high capacity positive active materials, graphite or carbon negative active materials, and very thick composite electrode coatings. However, since the active material coatings are thick, it is difficult to make wound cells, without the coatings flaking off of the current collector. As a result, mass and charge transport within the electrodes can become impeded.

Other approaches to increase the energy density of lithium-ion electrochemical cells include the substitution of the negative graphite anode with an active alloy capable of reacting with lithium. Such alloys may include one or more of the following electrochemical active elements—Si, Sn, Al, Ga, Ge, In, Bi, Pb, Zn, Cd, Hg, and Sb. However, the implementation of high energy cells by using alloy anodes have so far been difficult, and let to poor cycle life

### SUMMARY

As portable electronic devices become smaller, there is a need for more compact, higher energy batteries to power such devices. Furthermore, as lithium-ion battery technology usage is increased for “motive” applications (automobiles, scooters, and bicycles) there are additional needs for high energy, high discharge rate, long cycle life and lower cost.

In one aspect, a lithium-ion electrochemical cell is provided that includes a positive electrode that comprises a lithium mixed metal oxide having a first irreversible capacity; and a negative electrode that includes an alloy anode material having a first irreversible capacity when cycled to a delithiation voltage of 0.9 V vs. Li/Li⁺, wherein the lithium mixed metal oxide comprises at least one of nickel, cobalt, and manganese, wherein the alloy anode material comprises at least one of silicon and tin, and wherein the first cycle irreversible capacity of the positive electrode is greater than or equal to the first cycle irreversible capacity of the negative electrode cycled to a delithiation of 0.9 V vs. Li/Li⁺. The provided lithium-ion electrochemical cell can have a positive electrode with a lithium mixed metal oxide comprising the core shell compositions described in U.S. Ser. No. 61/444,247, filed Feb. 18, 2011 and entitled “Composite Particles, Methods of Making the Same, and Articles Including the Same” (Christensen). These compositions comprise nickel, manganese, and in some embodiments, cobalt. In other embodiments, the lithium mixed metal oxide positive electrode may comprise a composition having the formula, Liᵢ₊ₓ(NiₐMn_{b}Co_{c})₁₋ₓO₂, wherein 0.05≦x≦0.10,

a+b+c=1, 0.6≦b/a≦1.1, c/(a+b)<0.25, a, b, and c are all greater than zero. In all embodiments of the provided electrochemical cells, the first irreversible capacity of the lithium mixed metal composite positive electrode is larger than or equal to the first irreversible capacity of the alloy anode composite electrode when cycled to a delithiation voltage of 0.9V vs. Li/Li⁺. In some embodiments, the provided lithium-ion electrochemical cells include an alloy anode material that comprises both silicon and tin and, in some embodiments, also comprise iron. In other embodiments the anode comprises a mixture of alloy and graphite. In some embodiments, the positive electrode comprises a composition that includes a plurality of particles comprising a core having the formula, Liᵢ₊ₓ(NiₐMn_{b}Co_{c})₁₋ₓO₂, wherein 0.05≦x≦0.10, a+b+c=1, 0.6≦b/a≦1.1, c/(a+b)<0.25, a, b, and c are all greater than zero; and a shell substantially surrounding the core comprising a lithium mixed transition metal oxide comprising manganese and nickel, wherein the molar ratio of manganese to nickel is greater than b/a and b/a>1, and wherein said composition has a capacity retention of greater than about 95% after 50 cycles when comparing the capacity after cycle 52 with the capacity after cycle 2 when cycled between 2.5 V and 4.7 V vs. Li/Li⁺ at 30° C.

In another aspect, a method of making a lithium-ion electrochemical cell is provided that includes selecting a positive electrode that includes a lithium mixed metal oxide that has a first cycle irreversible capacity; selecting a negative electrode that includes an alloy anode that has a first cycle irreversible capacity when cycled to a delithiation of 0.9 V vs. Li/Li⁺; and constructing a lithium-ion electrochemical cell using an electrolyte, positive electrode and negative electrode, wherein the first cycle irreversible capacity of the positive electrode is greater than or equal to the first cycle irreversible capacity of the negative electrode.

In the present disclosure:

“active” or “electrochemically active” refers to a material that can undergo lithiation and delithiation by reaction with lithium;

“inactive” or “electrochemical inactive” refers to a material that does not react with lithium and does not undergo lithiation and delithiation;

“alloy active material” refers to a composition of two or more elements, at least one of which is a metal, and where the resulting material is electrochemically active;

“substantially surrounding” refers to a shell that almost completely surrounds the core, but may have some imperfections which expose very small portions of the core such as, for example, pinholes or small cracks;

“composite (positive or negative) electrode” refers to the active and inactive material that make up the coating that is applied to the current collector to form the electrode and includes, for example, conductive diluents, adhesion-promoters, and binding agents;

“cycling” refers to lithiation followed by delithiation or vice versa;

“first irreversible capacity” is the total amount of lithium capacity of an electrode that is lost during the first charge/discharge cycle which is expressed in mAh, or as a percentage of the total electrode, or, active component capacity;

“lithium mixed metal oxide” refers to a lithium metal oxide composition that includes one or more transition metals in the form of an oxide;

“negative electrode” refers to an electrode (often called an anode) where electrochemical oxidation and delithiation occurs during a discharging process; and

“positive electrode” refers to an electrode (often called a cathode) where electrochemical reduction and lithiation occurs during a discharging process.

The provided lithium-ion electrochemical cells meet the need for electrochemical cells that have high capacity and long cycle life. The provided electrochemical cells can have higher energy density than conventional lithium-ion electrochemical cells so that they are useful for powering advanced portable electronics, and various “motive” applications. The provided lithium-ion electrochemical cells can have much longer cycling life without significant loss of power than conventional cells.

The above summary is not intended to describe each disclosed embodiment of every implementation of the present invention. The brief description of the drawings and the detailed description which follows more particularly exemplify illustrative embodiments.

### BRIEF DESCRIPTION OF THE DRAWINGS

FIG. 1 is a composite graph voltage (V) vs. electrode capacity (mAh/g) of the first cycle of an electrochemical cell having lithium cobalt oxide charged to 4.5 V vs. Li/Li⁺ and graphite charged to 0.005 V vs. Li/LI⁺ as electrodes.

FIG. 2 is a composite graph voltage (V) vs. electrode capacity (mAh/g) of the first cycle for two electrochemical cells; one having lithium cobalt oxide charged to 4.5 V vs. Li/Li⁺, and one having a high capacity cathode (Li[Ni_{0.66}Mn_{0.34]O}₂) charged to 4.8 V vs. Li/Li⁺, with both cells having a composite alloy anode (Si₇₁Fe₂₅Sn₄) charged to 0.005 V vs. Li/Li⁺.

FIG. 3 is a composite graph of capacity (mAh/g) vs. cycle number for three 18650 cylindrical cells all having a composite alloy anode (Si₇₁Fe₂₅Sn₄) having various lithium metal oxide positive electrodes.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The provided lithium-ion electrochemical cells include a positive electrode comprising a metal oxide active material, having a first cycle irreversible capacity a negative electrode having a first cycle irreversible capacity when cycled to a delithiation of 0.9 V vs. Li/Li⁺, comprising an anode active alloy material and an electrolyte. Typically, the electrode materials are mixed with additives and then coated onto current collectors such as those described later in this disclosure, to form a composite electrode. To make an electrochemical cell, at least one positive electrode and at least one negative electrode are placed in proximity and separated by a thin porous membrane or separator. A common format for lithium-ion cells is an 18650 cylindrical cell (18 mm in diameter and 65 mm in length) or a 26700 cylindrical cell (26 mm in diameter and 70 mm long) in which a positive electrode-separator-negative electrode “sandwich” is rolled into a cylinder and placed in a cylindrical canister along with an electrolyte. Another common format is a flat cell in which the positive electrode-separator-negative electrode “sandwich” is layered into a flat, rectangular shape and placed in a container of the same shape that also contains electrolyte.

Commercial 18650 lithium-ion electrochemical cells have reached capacities of about 3.0 amp-hours (Ah) (11.25 Wh) based on LiCoO₂ as the positive electrode material and graphite as the negative electrode material. High energy density is accomplished by using fully dense composite electrodes and active materials with low irreversible capacities of from about 3 to about 8%. Attempts have been made to further increase the capacity and the energy density of lithium-ion electrochemical cells by utilizing higher capacity cathodes active materials, and thicker coated graphite negative electrodes. A disclosure of this approach can be found, for example, in U.S. Pat. Appl. Publ. No. 2009/0263707 (Buckley et al.).

Another approach to increasing the capacity of lithium-ion electrochemical cells is to use alloy negative electrode materials since they can incorporate much more lithium than graphite. Unfortunately, alloy negative electrode materials can have high porosity when coated and they tend to have significantly higher first cycle irreversible capacities than graphite—typically from about 10% to even greater than 25% capacity loss during the first cycle. It has been found, that the high porosity of alloy coatings can be minimized by blending with graphite. It has also been found that the best energy density in an electrochemical cell can be achieved when the irreversible capacity of the composite anode and the composite cathode are about equal. Efforts have been made to lower the first cycle irreversible capacity of alloy anodes in electrochemical cells, to better match, for example, LiCoO₂ positive electrodes, by the use of sacrificial lithium, or, by adding an irreversible source of lithium to the cathode composite—a very difficult task. However, several other high capacity positive electrode materials have significantly higher irreversible capacity than LiCoO₂ and have been considered poor matches with graphite as far as irreversible capacity is concerned. However, these other materials are better matched with alloy anode type electrodes. Additionally, alloy negative electrode materials tend to cycle poorly when used in a cell with a high density composite positive electrode such as LiCoO₂.

The cathode active materials for the provided high capacity lithium-ion electrochemical cells must be chosen to provide high specific and volumetric capacity and to provide irreversible capacity matching with the active negative electrode material. Using this strategy, it is possible to realize lithium-ion electrochemical cells, for example of the 18650 format, that can have up to about 3.6 Ah, or even higher total cell capacity, and long cycle life. The provided lithium-ion electrochemical cells have composite positive electrodes that include high voltage positive electrode materials that include a lithium mixed metal oxide having a first irreversible capacity and a negative electrode that includes an alloy anode material having a first irreversible capacity when cycled to a delithiation of 0.9 V vs. Li/Li⁺ wherein the first cycle positive electrode irreversible capacity is slightly higher or about the same as the first cycle irreversible capacity of the active alloy composite negative electrodes. The lithium mixed metal oxide includes at least one of nickel, cobalt, and manganese. The alloy anode material includes at least one of silicon and tin.

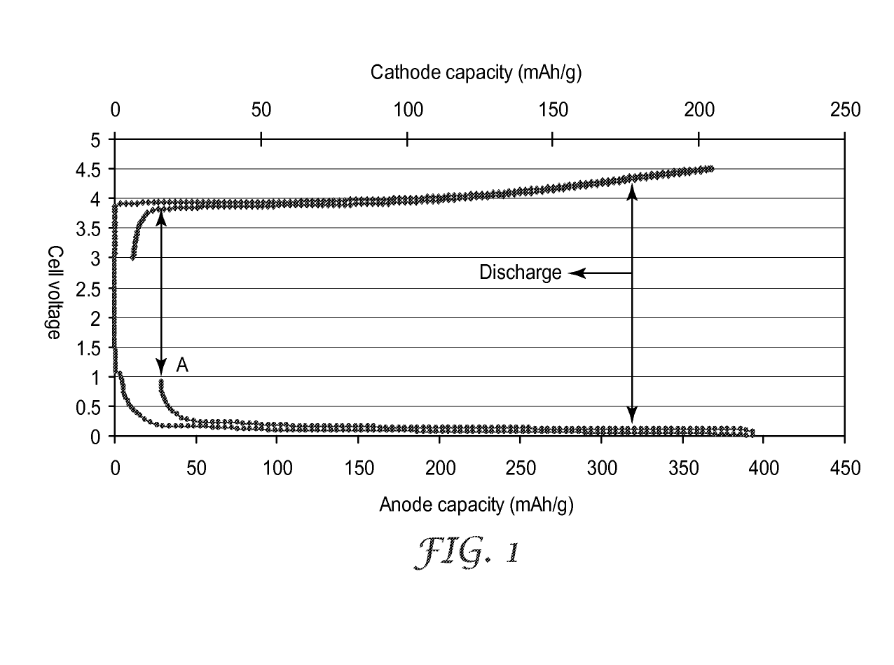

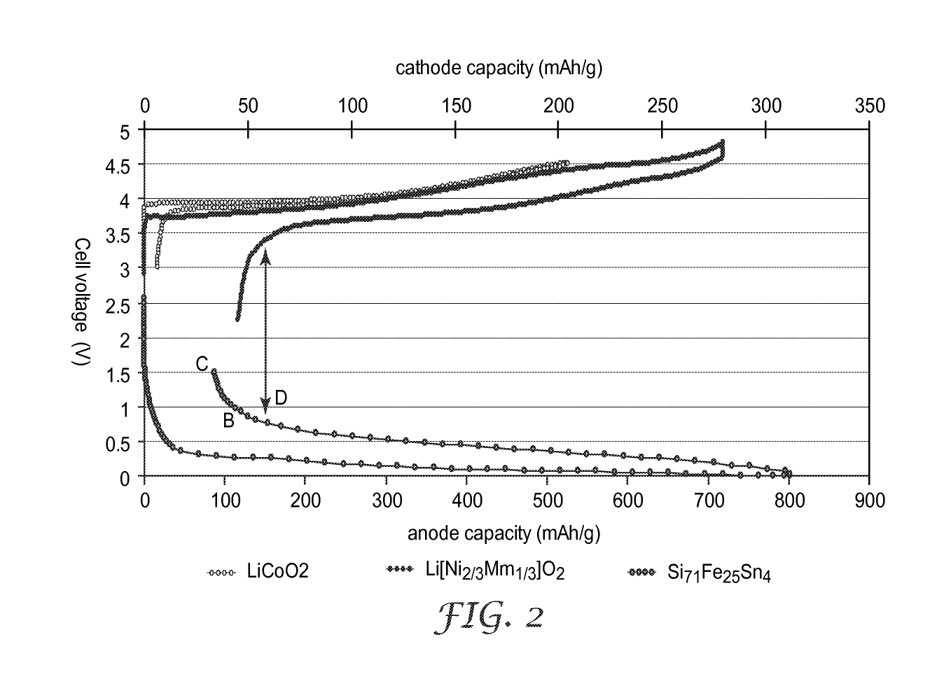

FIGS. 1 and 2 illustrate the concept behind the operation of the provided high capacity lithium-ion electrochemical cells. FIG. 1 is a composite graph of voltage (V) vs. electrode capacity (mAh/g) of the first cycle of an electrochemical cell having lithium cobalt oxide charged to 4.5 V vs. Li/Li⁺ and graphite charged to 0.005 V vs. Li/LI⁺ as electrodes. During discharge, the cell voltage follows along the cathode and anode discharge voltage curves until the point A is reached, where the anode voltage is about 1.0 V vs. Li/Li⁺ and the cathode voltage is about 3.8 V vs. Li/Li⁺. At point A the electrochemical cell is completely discharged and all of the lithium has been removed from the graphite anode. But the cathode is not completely discharged at this point since it can still take up more lithium if there was more to take up as evidenced by observation of the cathode voltage curve at the same capacity as point A (where the graphite is completely discharged). Taking the cell voltage below 2.8 V will rapidly force the voltage of the graphite negative electrode to be above 1 V vs. Li/Li⁺ at which voltage permanent damage to the graphite electrode can occur. FIG. 2 is a composite graph of the cell voltage (V) vs. electrode capacity (mAh/g) of the first cell cycle of two electrochemical cells, one having a lithium cobalt oxide positive electrode charged to 4.5 V vs. Li/Li⁺, and the other having a high capacity positive electrode, Li[Ni_{2/3}Mn_{1/3}]O₂, charged to 4.8 V vs. Li/Li⁺, and an alloy anode, Si₇₁Fe₂₅Sn₄ charged to 0.005 V vs. Li/Li⁺. The irreversible capacity of the lithium cobalt oxide positive electrode is much less than the irreversible capacity of the composite alloy anode. As the electrochemical cell becomes discharged and the cell voltage reaches 2.8 V vs. Li/Li⁺, the composite alloy anode will have reached 1 V vs. Li/Li⁺ at Point B. If the cell is discharged further to 2.5 V vs. Li/Li⁺, it will still be possible to extract a small additional capacity while the composite alloy anode will reach 1.5 V vs. Li/Li⁺ at Point C as shown. Composite alloy materials from which composite alloy anodes are made are known to undergo severe volumetric changes upon lithiation and delithiation. These volume changes can reach over 100% (volume change for fully lithiated Si is 280%) between fully lithiated and fully delithiated states of the material. This volumetric change can cause loss of electrical conductivity and associated capacity loss of the electrochemical cell—particularly between Points B and C where the active material contraction is the largest, and the anode voltage is rapidly changing. In order to minimize electrochemical cell capacity loss due to this severe final contraction, the composite alloy anode voltage should be kept below Point D, where the composite alloy voltage is below 0.9V vs Li/Li⁺. The negative effect of discharging the alloy anode above 0.9V is shown by the data in Table 1. Table 1 displays measured data of irreversible capacity (mAh/g) vs. cell voltage for a composite alloy anode along the delithiation curve to various voltages. For each recorded delithiation voltage the area specific impedance has been measured. As the cell voltage increases the irreversible capacity decreases, but the area specific impedance increases, particularly in the D to C range in FIG. 2. It is clear that keeping the alloy anode voltage below 0.9V vs. Li/Li⁺ when incorporated into an electrochemical cell will result in an optimal performance of high capacity and low deterioration.

TABLE 1
Capacity vs. Cell Voltage

| Cell Voltage | Irreversible Capacity | Area Specific Impedance |
|---|---|---|
| ((V) vs. Li/Li⁺) | (mAh/g) | (ohm-cm²) |
| 0.5 | 325 | 70 |
| 0.6 | 235 | 90 |
| 0.7 | 195 | 90-100 |
| 0.9 | 150 | 120 |
| 1.5 | 100 | 400 |

One way to prevent the anode from reaching too high a delithiation voltage in a full electrochemical cell is to match the composite alloy anode with a high capacity cathode (functional above 4.3 V vs. Li/Li⁺) having an irreversible capacity that is equal to or greater than the irreversible capacity of the alloy anode. In FIG. 2, Li[Ni_{2/3}Mn_{1/3}]O₂ is such a high capacity cathode material. Cell discharge below 2.5 V vs. Li/Li⁺ is prevented by the cathode voltage profile and the anode voltage will stay below about 0.7 V vs. Li/Li⁺ at full discharge (Point D on FIG. 2). This will cause a much improved cycle life. In some embodiments, the irreversible capacity of the cathode is about equal to that of the anode which will maximize the energy density.

Irreversible capacities (percentage of loss of capacity after the first charge/discharge cycle) for various metal oxide cathode materials are shown in Table 2. These irreversible capacities were measured from the first cycle of composite electrodes in 2325 coin cells against a metallic lithium counter electrode by charging the half-cell to an appropriate voltage (4.2 to 4.8V) then discharging to 2.5V at a rate of C/20. The materials that have two compositions listed such as, for example, Li_{1.06}{[Ni_{2/3}Mn_{1/3}]_{A}[Ni_{0.17}Mn_{0.56}CO_{0.17}]_{1-A}}O_{0.94}O₂, has a core that has nickel, manganese, in the atomic proportions shown surrounded by a shell that has nickel, manganese, and cobalt in the atomic proportions shown. These are explained later and there are some core-shell formulations that can operate at high cathode voltages (>4.3 V vs. Li/Li⁺) Table 3 is a list of alloy anode materials and their irreversible capacities which were measured from the first cycle of composite electrodes in 2325 coin cells against a metallic lithium counter electrode by lithiating the half-cell to 0.005V vs. Li/Li⁺, then delithiating to 0.9 V at a rate of C/10. These alloys all include active and inactive elements and have reversible volumetric capacities of between 2500 and 4000 Ah/L. Tables 2 and 3 are not meant to limit the possibilities of metal oxide cathode and alloy anode materials. Other materials are possible as long as they meet the cathode and anode matching requirements set forth herein.

TABLE 2
Irreversible Capacities of Metal Oxide Cathode Materials

| | Irreversible |
|---|---|
| Composition | Capacity (%) |
| LiCoO₂ | 3 |
| Li[Ni_{0.8}Co_{0.1}Al_{0.1}]O₂ | 6.3 |
| Li[Ni_{1/3}Mn_{1/3}Co_{1/3}]O₂ | 10.5 |
| Li[Ni_{0.42}Mn_{0.42}Co_{0.16}]O₂ | 11 |
| Li[Li_{0.05}Ni_{0.42}Mn_{0.53}]O₂ | 12 |
| Li_{1.06}{[Ni_{2/3}Mn_{1/3}]_{A}[Ni_{0.44}Mn_{0.55}]_{1-A}}_{0.94}O₂ | 13.8 |
| Li_{1.2}{[Ni_{2/3}Mn_{1/3}]_{A}[Ni_{0.25}Mn_{0.75}]_{1-A}}_{0.8}O₂ | 14 |
| Li_{1.06}{[Ni_{2/3}Mn_{1/3}]_{A}[Ni_{0.17}Mn_{0.56}Co_{0.17}]_{1-A}}_{0.94}O₂ | 16 |
| Li[Ni_{2/3}Mn_{1/3}]O₂ | 17 |
| Li[Ni_{0.5}Mn_{0.3}Co_{0.2}]O₂ | 17 |
| Li[Li_{0.20}Ni_{0.13}Co_{0.13}Mn_{0.54}]O₂ | 26 |
| Li_{1.2}{[Ni_{2/3}Mn_{1/3}]_{A}[Ni_{0.17}Mn_{0.56}Co_{0.17}]_{1-A}}_{0.8}O₂ | 31 |

TABLE 3
Capacities and Irreversible Capacities of Alloy Anode Materials

| | Irreversible |
|---|---|
| Composition | Capacity (%) |
| Si₆₀Al₁₄Fe₈Ti₁Sn₇Mm₁₀ | 15 |
| Si₇₁Fe₂₅Sn₄ | 15 |
| Si₅₇Al₂₈Fe₁₅ | 20 |
| Sn₃₀Co₃₀C₄₀ | 29 |

The provided high capacity (energy) lithium-ion electrochemical cells are derived from matching the irreversible capacity of the composite positive electrode, based on the active positive electrode material (expressed as a percentage), such that it is greater than or equal to the irreversible capacity of the composite negative electrode, based on the active negative electrode material when delithiated to 0.9 V vs. Li/Li⁺. Other factors, besides the intrinsic irreversible capacity of the active electrode material, like active blending of additives, conductive diluents, and even certain binders may also contribute to the irreversible capacity of the composite electrodes, and may even be used to “fine tune” the matched composite electrodes.

The provided lithium-ion electrochemical cells include a positive electrode, having a first cycle irreversible capacity that comprises a metal oxide cathode active material. The metals can include, for example, cobalt, nickel, manganese, lithium, vanadium, iron, and combinations thereof. Positive electrodes metal oxide cathode active materials useful in the provided electrochemical cells can include, for example, LiCo_{0.2}Ni_{0.8}O₂, LiNiO₂, LiFePO₄, LiMnPO₄, LiCoPO₄, LiMn₂O₄, and LiCoO₂; the positive electrode compositions that include mixed metal oxides of cobalt, manganese, and nickel such as those described in U.S. Pat. Nos. 6,964,828 and 7,078,128 (Lu et al.); and nanocomposite positive electrode compositions such as those described in U.S. Pat. No. 6,680,145 (Obrovac et al.). Other exemplary cathode active materials can include LiNi_{0.5}Mn_{1.5}O₄ and LiVPO₄F. Additional useful metal oxide active materials can be found, for example, in Japanese Pat. Publ. No. 11-307094 (Takahiro et al.), U.S. Pat. Nos. 5,160,172 and 6,680,143 (both Thackeray et al.); U.S. Pat. Nos. 7,358,009 and 7,635,536 (both Johnson et al.) and U.S. Pat. No. 8,012,624 (Jiang et al.); U.S. Pat. Appl. Publ. Nos. 2008/0280205; 2009/0239148 (Jiang); 2009/0081529 (Thackeray); and 2010/0015516 (Jiang).

Exemplary metal oxide cathode active materials include materials that have the formula, Li[Li_{(1-2y)/3}M¹_{y}Mn_{(2-y)3}]O₂, wherein 0.083<y<0.5 and M¹ represents Ni, Co or a combination thereof, and wherein the metal oxide composite active material is in the form of a single phase having an O3 crystal structure. These metal oxide composite active materials are particularly useful when the metal oxide composite active material does not undergo a phase transformation to a spinel crystal structure when incorporated into a lithium-ion electrochemical cell with an anodic material, such as lithium, and cycled from an upper voltage ranging between 4.4 V to 4.8 V to a lower voltage ranging from 2.0 V to 3.0 V for 100 charge-discharge cycles at 30° C.

Exemplary metal oxide composite active materials also include materials that have the formula, Li[M²_{y}M³_{1-2y}Mn_{y}]O₂, wherein 0.167<y<0.5, M² represents Ni or Ni and Li, and M³ represents Co, and wherein said positive electrode composition is in the form of a single phase having an O3 crystal structure, and Li[M⁴_{y}M⁵_{1-2y}Mn_{y}]O₂, wherein 0.167<y<0.5, M⁴ represents Ni and M⁵ represents Co or Co and Li, and wherein said positive electrode composition is in the form of a single phase having an O3 crystal structure. These materials are also particularly useful when the metal oxide active material does not undergo a phase transformation to a spinel crystal structure when incorporated into a lithium-ion electrochemical cell with an anodic material, such as lithium, and is cycled from an upper voltage ranging between 4.4 V to 4.8 V to a lower voltage ranging from 2.0 V to 3.0 V for 100 charge-discharge cycles at 30° C.

In other embodiments, the provided lithium-ion electrochemical cells can include positive electrodes that have metal oxide cathode active materials that include, for example, Li[Ni_{2/3}Mn_{1/3}]O₂, Li[Ni_{0.50}Mn_{0.30}Co_{0.20}]O₂, Li[Ni_{1/3}Mn_{1/3}Co₃]O₂, or Li[Ni_{0.42}Mn_{0.42}Co_{0.16}]O₂. In some embodiments, the positive electrodes can have excess lithium—2 mole % or more, 5 mole % or more, 10 mole % or more, or even 20 mole % or more. Useful metal oxide composite active materials can be in an O3 layered structure. In the O3 structure, these composites have alternating layers of lithium-metal-oxygen-metal-lithium. The layered structure facilitates reversible movement of lithium into and out of the structure.

Certain oxide compositions allow the incorporation of additional Li (excess Li) into the layered structure. This allows for the formation of a solid state solution of LiMnO₂ and Li₂MnO₃. When such virgin lithium mixed metal oxide material is first charged, lithium ions (and electrons) are removed from the layered structure. If the voltage is raised high enough and the transition metal layer has reach its highest oxidation state i.e., greater than about 4.6 V vs. Li/Li⁺, electrons can still be forced to leave the layered structure at the irreversible expense of oxygen. At these higher voltages this is known as “oxygen loss”. Commercial NMC materials do not show a strong oxygen loss character when taken to 4.8V, and if cycled above 4.4V display poor capacity retention.

When some lithium mixed metal oxides (NMC oxides) have between 5 and 10 percent excess lithium and are prepared by firing at a narrow temperature range of 850° C. to 925° C., materials with improved cycling at high voltages can be produced. These materials as disclosed, for example, in U.S. Ser. No. 61/529,307, entitled “High Capacity Positive Electrodes for Use in Lithium-ion Electrochemical Cells and Methods of Making Same”, filed Aug. 31, 2011 (Christensen et al.). It has additionally been found that this improved performance is not universal, but composition dependent. NMC oxides only display this cycling improvement when the molar ratio of cobalt to the sum of the remaining transition metal is less than 25% and the molar ratio of Mn to Ni is between 1.1 and 0.6. Materials of the formula, Li₁₊ₓ(NiₐMn_{b}Co_{c})₁₋ₓO₂, wherein a+b+c=1, b/c=0.6 to 1.1, and x=0.05 to 0.1 meet this requirement.

Other useful positive electrodes for high capacity lithium-ion electrochemical cells compositions having the formula, Li₁₊ₓ(NiₐMn_{b}Co_{c})₁₋ₓO₂, wherein 0.05≦x≦0.10, a+b+c=1, 0.6≦b/a≦1.1, and c/(a+b)<0.25. Additionally, these electrodes are characterized in that the composition has a capacity retention of greater than about 95% after 50 cycles comparing the capacity after cycle 2 to the capacity after cycle 52 when cycled between 2.5 V and 4.7 V vs. Li/Li⁺ at 30° C. In some embodiments, 0.10≦c≦0.20. In other embodiments, the ratio of b to a or b/a is about 1. In some embodiments, 0.05≦x≦0.07. In some embodiments, said composition has a capacity retention of greater than about 90% after 50 cycles comparing the capacity after cycle 2 to the capacity after cycle 52 when cycled between 2.5 V and 4.7 V vs. Li/Li⁺ at 50° C.

In some embodiments, positive electrodes are provided that comprise a composition that includes a plurality of particles having a core and being substantially surrounded by a shell, the core having the formula, Li₁₊ₓ(NiₐMn_{b}Co_{c})₁₋ₓO₂, wherein 0.05≦x≦0.10, a+b+c=1, 0.6≦b/a≦1.1, c/(a+b)<0.25, and the shell comprising a lithium mixed transition metal oxide comprising manganese and nickel wherein the molar ratio of manganese to nickel is greater than 1, wherein said composition has a capacity retention of greater than about 95% after 50 cycles recorded at the same rate cycled between 2.5 V and 4.7 V vs. Li/Li⁺ at 30° C. Additionally, these electrodes are characterized in that the composition has a capacity retention of greater than about 95% after 50 cycles comparing the capacity after cycle 2 to the capacity after cycle 52 when cycled between 2.5 V and 4.7 V vs. Li/Li⁺ at 30° C. In some embodiments, 0.10≦c≦0.20. In other embodiments, the ratio of b to a or b/a is about 1. In some embodiments, 0.05≦x≦0.07. In some embodiments, said composition has a capacity retention of greater than about 90% after 50 cycles recorded at the same rate cycled between 2.5 V and 4.7 V vs. Li/Li⁺ at 50° C.

The provided lithium-ion electrochemical cells also include a negative electrode having a first cycle irreversible capacity and comprising an alloy active material. Useful alloy active materials include silicon, tin, or a combination thereof. Additionally, the alloys can include inactive elements including at least one transition metal. Suitable transition metals include, but are not limited to, titanium, vanadium, chromium, manganese, iron, cobalt, nickel, copper, zirconium, niobium, molybdenum, tungsten, and combinations thereof. Some embodiments of these compositions can also contain other inactive elements such as indium, silver, lead, iron, germanium, titanium, molybdenum, aluminum, phosphorus, gallium, and bismuth, and combinations thereof as inactive elements. The alloy active materials can also, optionally, include inactive elements such as aluminum, indium, carbon, or one or more of yttrium, a lanthanide element, an actinide element or combinations thereof. Suitable lanthanide elements include lanthanum, cerium, praseodymium, neodymium, promethium, samarium, europium, gadolinium, terbium, dysprosium, holmium, erbium, thulium, ytterbium, and lutetium. Suitable actinide elements include thorium, actinium, and protactinium. Some alloy compositions contain a lanthanide elements selected, for example, from cerium, lanthanum, praseodymium, neodymium, or a combination thereof.

Typical alloy active materials can include greater than 55 mole percent silicon. They can also include transition metals selected from titanium, cobalt, iron, and combinations thereof. Useful alloy active materials can be selected from materials that have the following components, SiAlFeTiSnMm, SiFeSn, SiAlFe, SnCoC, and combinations thereof where “Mm” refers to a mischmetal that comprises lanthanide elements.

Exemplary active alloy materials include Si₆₀Al₁₄Fe₈TiSn₇Mm₁₀, Si₇₁Fe₂₅Sn₄, Si₅₇Al₂₈Fe₁₅, Sn₃₀Co₃₀C₄₀, or combinations thereof. The active alloy materials can be a mixture of an amorphous phase that includes silicon and a nanocrystalline phase that includes an intermetallic compound that comprises tin. Exemplary alloy active materials useful in the provided lithium-ion electrochemical cells can be found, for example, in U.S. Pat. No. 6,680,145 (Obrovac et al.), U.S. Pat. No. 6,699,336 (Turner et al.), and U.S. Pat. No. 7,498,100 (Christensen et al.) as well as in U.S. Pat. No. 7,906,238 (Le), U.S. Pat. Nos. 7,732,095 and 7,972,727 (both Christensen et al.), U.S. Pat. Nos. 7,871,727, and 7,767,349 (both Obrovac et al.).

Provided electrochemical cells require an electrolyte. A variety of electrolytes can be employed. Representative electrolytes can contain one or more lithium salts and a charge-carrying medium in the form of a solid, liquid or gel. Exemplary lithium salts are stable in the electrochemical window and temperature range (e.g. from about −30° C. to about 70° C.) within which the cell electrodes can operate, are soluble in the chosen charge-carrying media, and perform well in the chosen lithium-ion cell. Exemplary lithium salts include LiPF₆, LiBF₄, LiClO₄, lithium bis(oxalato)borate, LiN(CF₃SO₂)₂, LiN(C₂F₅SO₂)₂, LiAsF₆, LiC(CF₃SO₂)₃, and combinations thereof. Exemplary solid electrolytes include polymeric media such as polyethylene oxide, fluorine-containing copolymers, polyacrylonitrile, combinations thereof and other solid media that will be familiar to those skilled in the art. Exemplary liquid electrolytes include ethylene carbonate, propylene carbonate, dimethyl carbonate, diethyl carbonate, ethyl-methyl carbonate, butylene carbonate, vinylene carbonate, fluoroethylene carbonate, fluoropropylene carbonate, γ-butyrolactone, methyl difluoroacetate, ethyl difluoroacetate, dimethoxyethane, diglyme (bis(2-methoxyethyl)ether), tetrahydrofuran, dioxolane, combinations thereof and other media that will be familiar to those skilled in the art. Exemplary electrolyte gels include those described in U.S. Pat. No. 6,387,570 (Nakamura et al.) and U.S. Pat. No. 6,780,544 (Noh). The electrolyte can include other additives that will be familiar to those skilled in the art. For example, the electrolyte can contain a redox chemical shuttle such as those described in U.S. Pat. Appl. Publ. No. 2009/0286162 (Lamanna et al.).

Composite electrodes, such as the provided positive and negative electrodes, can contain additives familiar to those skilled in the art. The electrode composition can include an electrically conductive diluent to facilitate electron transfer between the composite electrode particles and between the particles and current collector. Electrically conductive diluents can include, but are not limited to, carbon black, metal, metal nitrides, metal carbides, metal silicides, and metal borides. Representative electrically conductive carbon diluents include carbon blacks such as SUPER P and SUPER S (both from MMM Carbon, Belgium), SHAWANIGAN BLACK (Chevron Chemical Co., Houston, Tex.), acetylene black, furnace black, lamp black, graphite, carbon fibers and combinations thereof.

The electrode composition can include an adhesion promoter that promotes adhesion of the composition and/or electrically conductive diluent to the binder. The combination of an adhesion promoter and binder can help the electrode composition better accommodate volume changes that can occur in the composition during repeated lithiation/delithiation cycles. Alternatively, the binders themselves can offer sufficiently good adhesion to metals and alloys so that addition of an adhesion promoter may not be needed. If used, an adhesion promoter can be made a part of the binder itself (e.g., in the form of an added functional group), can be a coating on the composite particles, can be added to the electrically conductive diluent, or can be a combination of such measures. Examples of adhesion promoters include silanes, titanates, and phosphonates such as those described in U.S. Pat. No. 7,341,804 (Christensen).

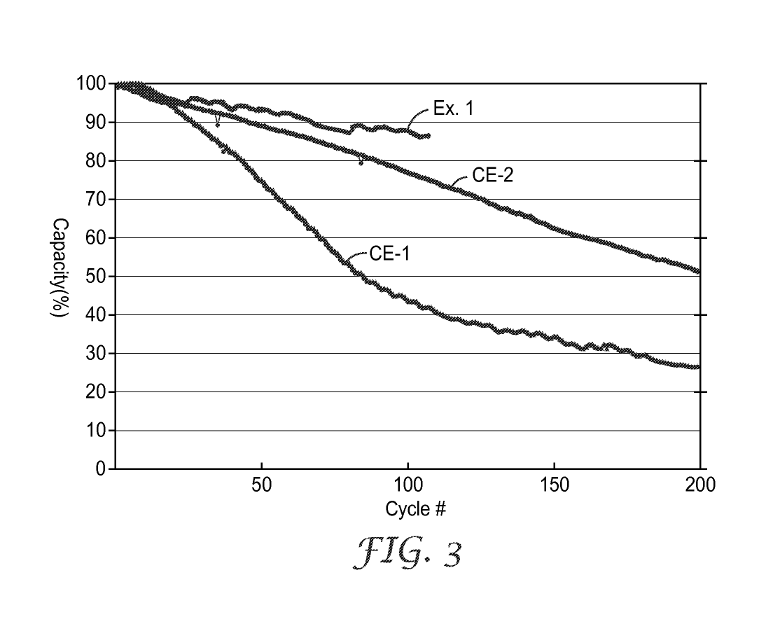

FIG. 3 is a composite graph of capacity (mAh/g) vs. cycle number for three 18650 cylindrical cells all having a composite alloy anode (Si₇₁Fe₂₅Sn₄) having various lithium metal oxide positive electrodes. The curve labeled Ex. 1 (Example 1) shows the cycling of a 18650 cylindrical cell having Li[Ni_{2/3}Mn_{1/3}]O₂ as the positive electrode material. The cycling of the cell out past 100 cycles shows greater than 85% capacity retention based on the capacity after the first cycle. Example 1 has a cathode with an irreversible capacity of 17% vs. Li/Li⁺. The alloy anode composite, Si₇₁Fe₂₅Sn₄, has an irreversible capacity of about 15% vs. Li/Li⁺ (see Tables 2 and 3). In contrast, Comparative Example 1 (CE-1) shows poor capacity at cycle 100 and beyond. CE-1 is an 18650 cylindrical cell having lithium cobalt oxide (LC) with an irreversible capacity of 3% vs. Li/Li⁺. CE-2 shows the capacity retention as a function of cycle number for an 18650 cylindrical cell having Li[Ni_{1/3}Mn_{1/3}Co_{1/3}]O₂which has an irreversible capacity of 10.5% vs. Li/Li⁺. In CE-2, the irreversible capacity of the positive electrode vs. Li/Li⁺ is less than the irreversible capacity of the negative electrode vs. Li/Li⁺ but much closer. The capacity falls off to about 75% retention after 100 cycles which is better than the cell with LCO as the positive material but not as good as the capacity retention for Example 1.

Various modifications and alterations to this invention will become apparent to those skilled in the art without departing from the scope and spirit of this invention. It should be understood that this invention is not intended to be unduly limited by the illustrative embodiments and examples set forth herein and that such embodiments are presented by way of example only with the scope of the invention intended to be limited only by the claims set forth herein as follows. All references cited in this disclosure are herein incorporated by reference in their entirety.

1. A lithium-ion electrochemical cell comprising:
a positive electrode that includes a lithium mixed metal oxide having a first irreversible capacity; and
a negative electrode that includes an alloy anode material having a first irreversible capacity when the anode is delithiated to 0.9 V vs. Li/Li⁺,
wherein the lithium mixed metal oxide comprises at least one of nickel, cobalt, and manganese,
wherein the alloy anode material comprises at least one of silicon and tin, and
wherein the first cycle irreversible capacity of the positive electrode is greater than or equal to the first cycle irreversible capacity of the negative electrode.

2. A lithium-ion electrochemical cell according to claim 1, wherein the lithium mixed metal oxide positive electrode comprises nickel and manganese.

3. A lithium-ion electrochemical cell according to claim 2, wherein the lithium mixed metal oxide positive electrode has a molar ratio of manganese to nickel of about 0.5.

4. A lithium-ion electrochemical cell according to claim 2, wherein the lithium mixed metal oxide positive electrode comprises a composition having the formula,
Li₁₊ₓ[(NiₐMn_{b}Co_{c})₁₋ₓ]O₂,
wherein 0.05≦x≦0.10, a+b+c=1, 0.8≦b/a≦1.1, c/(a+b)<0.25, a, b, and c are all greater than zero.

5. A lithium-ion electrochemical cell according to claim 4, wherein said composition has a capacity retention of greater than about 95% after 50 cycles compared to the capacity after the first cycle when cycled between 2.5 V and 4.7 V vs. Li/Li⁺ at 30° C.

6. A lithium-ion electrochemical cell according to claim 4, wherein b/a is about 1.

7. A lithium-ion electrochemical cell according to claim 4, wherein 0.05≦x≦0.07.

8. A lithium-ion electrochemical cell according to claim 4, wherein the composition has been prepared by heating to a temperature ranging from 850° C. to 925° C.

9. A lithium-ion electrochemical cell according to claim 2, wherein the positive electrode comprises a composition that comprises a plurality of particles comprising:
a core having the formula,
Li₁₊ₓ[(NiₐMn_{b}Co_{c})₁₋ₓ]O₂,
wherein 0.05≦x≦0.10, a+b+c=1, 0.8≦b/a≦1.1, c/(a+b)<0.25, a, b, and c are all greater than zero; and
a shell at least partially surrounding the core comprising a lithium mixed transition metal oxide comprising manganese and nickel wherein the molar ratio of manganese to nickel is greater than b/a and b/a>1,
wherein said composition has a capacity retention of greater than about 95% after 50 cycles compared to the capacity after the first cycle when cycled between 2.5 V and 4.7 V vs. Li/Li⁺ at 30° C.

10. A lithium-ion electrochemical cell according to claim 9, wherein the core has a formula wherein 0.10≦c≦0.20.

11. A lithium-ion electrochemical cell according to claim 9, wherein the core has a formula wherein 0.05≦x≦0.07.

12. A lithium-ion electrochemical cell according to claim 9, wherein the composition has been prepared by heating to a temperature ranging from 850° C. to 925° C.

13. A lithium-ion electrochemical cell according to claim 9, wherein said composition has a capacity retention of greater than about 90% after 50 cycles compared to the capacity after the first cycle when cycled between 2.5 V and 4.7 V vs. Li/Li+ at 50° C.

14. A lithium-ion electrochemical cell according to claim 9, wherein the core has a formula, Li_{1.06}[Ni_{0.42}Mn_{0.42}Co_{0.16}]O₂ and the shell has a ratio of b/a of 1.27.

15. A lithium-ion electrochemical cell according to claim 1, wherein the alloy anode material comprises both silicon and tin.

16. A lithium-ion electrochemical cell according to claim 15, wherein the alloy anode has a composition further comprises iron.

17. A lithium-ion electrochemical cell according to claim 16, wherein the alloy anode has a composition selected from Si₇₁Fe₂₅Sn₄, Si₆₀Al₁₄Fe₈Ti₁Sn₇(MM)₁₀, and combinations thereof.

18. A lithium-ion electrochemical cell according to claim 1, wherein the alloy anode further comprises active and inactive elements and has a reversible volumetric capacity of between about 2500 and 4000 Ah/L.

19. A method of making a lithium-ion electrochemical cell comprising:
selecting a positive electrode that includes a lithium mixed metal oxide that has a first cycle irreversible capacity;
selecting a negative electrode that includes an alloy anode that has a first cycle irreversible capacity when delithiated to 0.9 V vs. Li/Li⁺; and
constructing a lithium-ion electrochemical cell using an electrolyte, positive electrode and negative electrode,
wherein the first cycle irreversible capacity of the positive electrode is greater than or equal to the first cycle irreversible capacity of the negative electrode.
